(19) United States
(12) Patent Application Publication
(10) Pub. No.: US 2010/0287416 A1
(43) Pub. Date: Nov. 11, 2010

(54) METHOD AND APPARATUS FOR EVENT DIAGNOSIS IN A COMPUTERIZED SYSTEM

(75) Inventors: Lanir Naftaly SHACHAM, Ramat-Hasharon (IL); Oren Shlomo ELIAS, Herzeliya (IL)

Correspondence Address: SOROKER-AGMON ADVOCATE AND PATENT ATTORNEYS, NOLTON HOUSE, 14 SHENKAR STREET, HERZELIYA PITUACH, 46725, IL

(73) Assignee: CORRELSENSE LTD, Herzelia Pituach (IL)

(21) Appl. No.: 12/441,565

(22) Filed: Mar. 17, 2009

(51) Int. Cl. G06F 11/07

(52) U.S. Cl. 714/39; 714/E11.029

(57) ABSTRACT

A method and apparatus for diagnosis of a computerized system, the method comprising the steps of collecting one or more events; transforming the events to events based time series, said events based time series having intervals; determining which resources of the computerized system are being consumed by which events, for a first predetermined time interval; and determining a function between the events based time series and one or more measurable attributes of one or more resources that were consumed by the events for a second predetermined time interval.

### BACKGROUND OF THE INVENTION

1. Field of the Invention

The present invention generally relates to an apparatus and a corresponding method for event diagnosis. More specifically, the present invention relates to event diagnosis in a computerized system using classification of the different events in the computerized system leading to error correction and solving.

2. Discussion of the Related Art

Computerized systems no longer involve a single closed system and the use of multi-tier software architectures in which the database or the application servers are separate from the end user has many advantages. One benefit is that maintenance of servers and databases can be performed by a skilled person in a remote location, while the clients and users can still use the computerized system far a way from that remote location. Another benefit is the data security aspects. The data can be always backed up in a safe remote location while the clients and users can be located in areas where back up facilities are not available or are less reliable. Another benefit is the simplicity of using the same computerized online system for large organizations having few remote branches. As a result, even the simple application consists of several systems (nodes) that interact via well defined protocols. In a non limiting example, a simple user request for a web page describing product specifications in an e-commerce system may be translated by the browsing computer program into an HTTP request over TCP over IP, which incase of overcoming the fire wall and the anti-virus proxy, is load balanced by a load balancer and intercepted by a web server. The web server then delegates the request to a web container which translates this request to IIOP/RMI/SOAP procedure calls at the application server which will then modify them again to JDBC or JMS or SOAP in order to access the database or MOM (Message Oriented Middleware) or external applications via EAI (Enterprise Application Integration) interfaces and a like. A failure at a single node or tier can affect another remote node or tier or even the whole application such that the root cause of the malfunction is indirect and is difficult to discover. A typical application may generate numerous log files that need to be looked at before revealing the cause of the failure, but due to the vast amount of information gathered, cross reference between all the different utilized resources from one hand, and all the application events from the other, is substantially a challenging task. Thus, identifying the root cause of a problem is extremely difficult and requires substantial resources.

Computerized system failures can be divided into three groups. The first group is a permanent failure in which the computerized system error remains until the root cause for that error is fixed. The second group is a specific circumstance failure in which the computerized system error reoccurs only under specific circumstances. The third group is a single occurrence failure in which the computerized system error occurred once or twice. Now available monitoring tools provide minor assistance for the first and second groups and in a case of a single event that was not logged no assistance for the third group. Furthermore, a single node monitoring tool lacks the ability to perform a multi-tier analysis and ignores by a definition other environmental factors. Current multi-tier monitoring tools are designed to address specific system architecture and a monitoring tool for a first company's Enterprise Resource Planning (ERP) using a second company's database installed on a third company's server platform will not be useful for other ERP applications. One example for the lack of capabilities of currently available assisting tools is that these tools focus on optimization or monitoring of only a single component of the computerized system, and a tool monitoring the databases might recommend that a given SQL (Structured Query Language) statement should be re-written to reduce imposed I/O load while the actual problem may be a bottleneck I/O contention of fragmentation.

There is therefore a need for a multi-tier monitoring tool which is platform independent and software component independent and will take under consideration substantially all the resources from the different tiers of the computerized system. The multi-tier monitoring tool will preferably eliminate the need for looking at the different log files of the different tiers of the computerized system. The monitoring tool will preferably assist in analyzing the root cause of a failure enabling the user to manipulate the configuration of the computerized system in order to prevent the same root cause to reoccur. The monitoring tool will preferably alert the user of a possible failure before it occurred. The monitoring tool will be preferably a generic and adaptive tool in such that a share data which was acquired at one environment will be useful in a different environment.

### SUMMARY OF THE PRESENT INVENTION

The present invention overcomes the disadvantages of the present art by providing a new and novel method and apparatus for event diagnosis in computerized systems.

In some exemplary embodiments of the present invention there is provided an apparatus and a method for event diagnosis that does not require searching of errors and anomalies at the different log files of the different parts of the computerized system. One benefit of the present exemplary embodiment relates to error correction and error solving in large multi-tier computerized systems and environments.

In some exemplary embodiments of the present invention the apparatus and method are using classification of the various events in the computerized system according to various measurable attributes of the resource. In such a way, specific overloads and bottlenecks in resources can be easily identified by a person skilled in the art, and the root cause of a possible malfunctioning of the computerized system can then be solved. Another benefit of the present invention is that the computerized system personnel may classify and diagnose substantially all the failures that may occur during the operation of the computerized system before their occurrence simply by classification of the various events in the computerized system according to the various measurable attribute of the resource. Such system can, in some exemplary embodiments, be a network system or a combination of computerized and network systems. The classification of the events is measurable by the various attributes of each consumed resource. The measurable attributes can comprise, in some exemplary embodiments of the present invention: time; consumed time; speed; network speed; storage space; available space; space; free space; bit rate or byte rate; read or write queue length; average queue length; temporary queue length; read or write time; transfer time; idle time; split i/o; packets; packets received; packets sent; packets per sec; bandwidth; received bytes; page faults; available bytes; committed bytes; commit limit; write copies; transition faults; cache faults; demand zero faults; pages input; page reads; pages output; pool paged; pool non-paged; page writes; free system page table entries; cache; cache peak; pool paged resident; system code total; system resident code; system total resident; system total driver; packets received; packets sent; packets error; packets unknown; system driver; system resident driver; system resident cache; committed in use; processor time; user time; interrupt; threads; processes; system up time; alignment fixups; exception dispatches; floating emulations; registry quota in use; file read operations; file write operations; file control operations; file read bytes; file write bytes; file control bytes; context switches; system calls; file data operations; system up time; processor queue length; memory page faults; page file sys usage; page file sys peak; and the like.

One or more of the said attributes can be measured per seconds; bytes per seconds; seconds; bytes; bytes length; queue length; packets and the like.

In some exemplary embodiments of the present invention the apparatus and method are generating an event profile taking under consideration substantially all resources of the different tiers of the computerized system, such system can in some exemplary embodiments be substantially all of the now known or later topologies and applications.

In another exemplary embodiments of the present invention there is provided an apparatus and a method for detecting events prior to resource malfunction, a group of over consuming events, a single resource bottleneck which occurs when events are consuming the same resource, events locking situation, and a like. Such a model of event to resource relation is essential for automatic problem and root-cause detection.

Thus, in accordance with the present invention there is provided a method for diagnosis of a computerized system, the method is implemented within a computing platform, the platform comprises one or more processing units, one or more storage devices; and one or more communication devices, the method comprising the steps of collecting events or extracting data elements generated by an element of the computerized system; transforming the events or data elements to one or more event based time series, said one or more event based time series having one or more interval; determining which resources of the computerized system is consumed by which events, for a first predetermined time interval; and determining a function between the one or more event based time series and measurable attributes of the resources for the events for a second predetermined time interval. The method further comprises a step of storing events or data elements generated by an element of the computerized system in a database. The first predetermined time interval is longer than or equal to the second predetermined time interval. The second predetermined time interval is contained in the first predetermined time interval. The method further comprising a step of determining a function between the one or more event based time series and the measurable attributes of the resources for the events for a third predetermined time interval. The third predetermined time interval is different from the second predetermined time interval. The step of determining the function between the one or more event based time series and measurable attributes of the resources for the events comprises the use of minimum least square method step or by iteratively introducing weights into the said step. The event can be an event type, and the resource can be a consumed resource.

In accordance with the present invention, there is also provided an apparatus for diagnosis of a computerized system, the apparatus is implemented within a computing platform, the platform comprises a processing unit, a storage device; and a communication device, the apparatus comprising a collecting module for collecting information about the computerized system; a database for storing the information collected by the said collecting module; and an analyzing module for performing event diagnosis on the information collected by said collecting module and stored by said database. The apparatus further comprising a transforming module for transforming the information stored on said database to a predetermined form to be analyzed by said analyzing module for further processing. The apparatus further comprising a data visualization module for receiving and presenting the results of the event diagnosis performed by said analyzing module. The apparatus further comprising a display module for viewing the results of the event diagnosis received from the said data visualization module.

### BRIEF DESCRIPTION OF THE DRAWINGS

The present invention will be understood and appreciated more fully from the following detailed description taken in conjunction with the drawings. In the drawings like numerals refer to the same elements.

FIG. 1 is a schematic illustration of the main components of a multi-tier computerized system, in accordance with a preferred embodiment of the present invention.

FIG. 2A illustrates a block diagram of the apparatus of the event diagnosis in the computerized system, in accordance with a preferred embodiment of the present invention.

FIG. 2B illustrates a block diagram of the method of operation of the event diagnosis in the computerized system, in accordance with a preferred embodiment of the present invention.

FIG. 2C illustrates a block diagram of step 280 of FIG. 2B of the method of operation of the analyzing module 230 of FIG. 2A, in accordance with a preferred embodiment of the present invention.

FIGS. 3A, 3B are schematic illustrations of exemplary information recorded and stored at the database or repository 210 of FIG. 2, in accordance with a preferred embodiment of a present invention.

FIG. 4 is a graph illustration of an exemplary consumption of a resource by an event type, in accordance with a preferred embodiment of the present invention.

FIG. 5 is a schematic illustration of an exemplary display result of the resources consumption by exemplary events types of the computerized system, in accordance with a preferred embodiment of the present invention.

### DETAILED DESCRIPTION OF THE PREFERRED EMBODIMENT

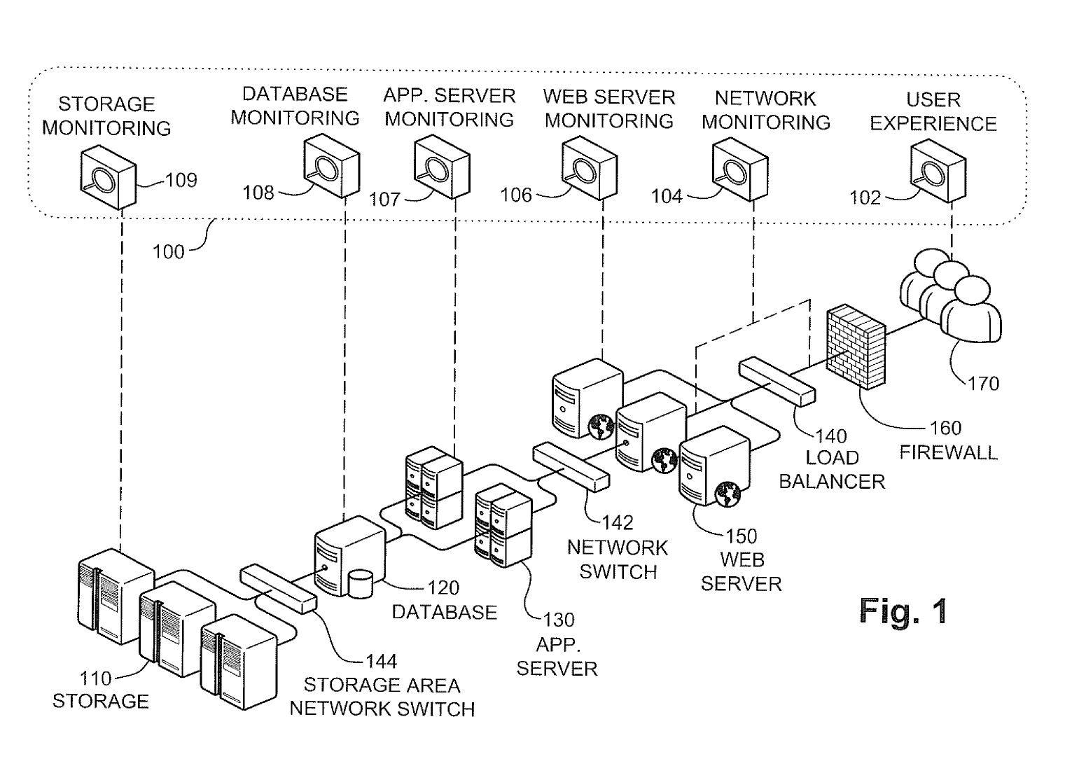

FIG. 1 is a schematic illustration of the main components of a typical exemplary computerized system, in accordance with a preferred embodiment of the present invention, in which the present invention can be typically operated. User 170 of the computerized system sends a request (not shown) to web server 150. In some exemplary embodiments of the present invention, the user 170 is being monitored by user experience monitoring tool 102. The user 170 uses output and input devices such as a keyboard, a mouse and a display In some exemplary embodiments of the present invention, the request is a request for a web page or other services and is translated by the browser to an HTTP (hypertext transfer protocol) request over TCP/IP (Transmission Control Protocol Internet Protocol). The exemplary request overcomes a firewall or an anti-virus proxy 160 load balanced by a load balancer 140 and intercepted by web server 150. The web server 150 then delegates the request to a web container (not described) which translates the request to IIOP or RMI or SOAP procedure calls to an application server 130 transported. The request is transported by the network switch 142 to the application server 130. Application server 130 transforms the request to JDBC or JMS or SOAP calls in order to access database 120 or MOM or external application via EAI interfaces and a like. Accessing storage 110 is done by Storage Area Network (SAN) switch 144. Substantially all computerized system resources are monitored by monitoring device 100 as following: end user 170 requests are monitored by user experience monitoring tool 102, load balancer 140 is monitored by network monitoring 104, web server 150 is monitored by web server monitor 106, application server is monitored by application server monitoring 107, database 120 is monitored by database monitoring 108, storage 110 is monitored by storage monitoring 109. In some exemplary embodiments of the present invention, user experience monitoring tool 102 monitors the average response time of the requests sent by the end user 170. Sniffing programs or port mirror programs can be used, in some exemplary embodiments of the present invention, for collecting network traffic, at network monitoring tool 104, from which events or resource data can be extracted.

Monitoring device 100 is monitoring continuously, in some exemplary embodiments of the present invention, the consumption time of the computerized system resources. At each computerized system node or tier the data is manipulated and influence potentially the entire computerized system such that, in some exemplary embodiments of the present invention, a failure at a single point causes a failure of the request of the user 170. Permanent failures which cause the computerized system to stop functioning and specific circumstance failures that are a result of a specific chain of events may create substantial delay and damage.

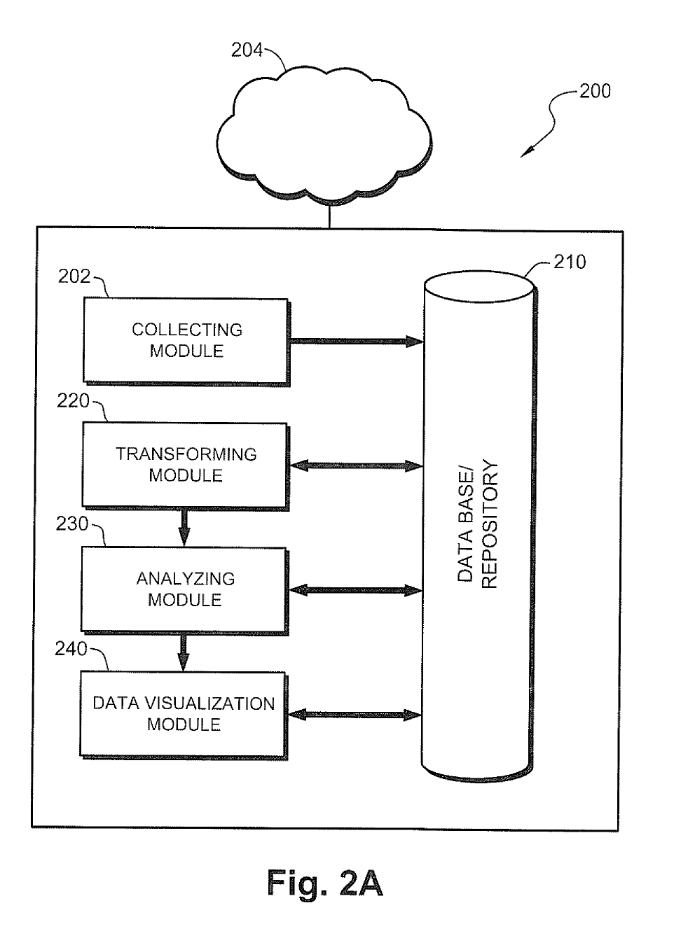

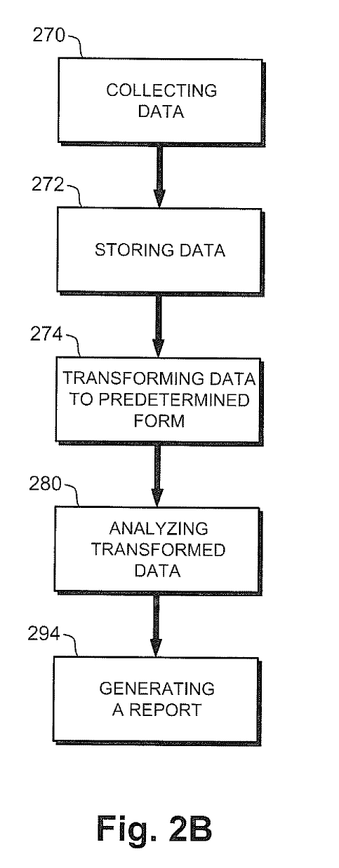

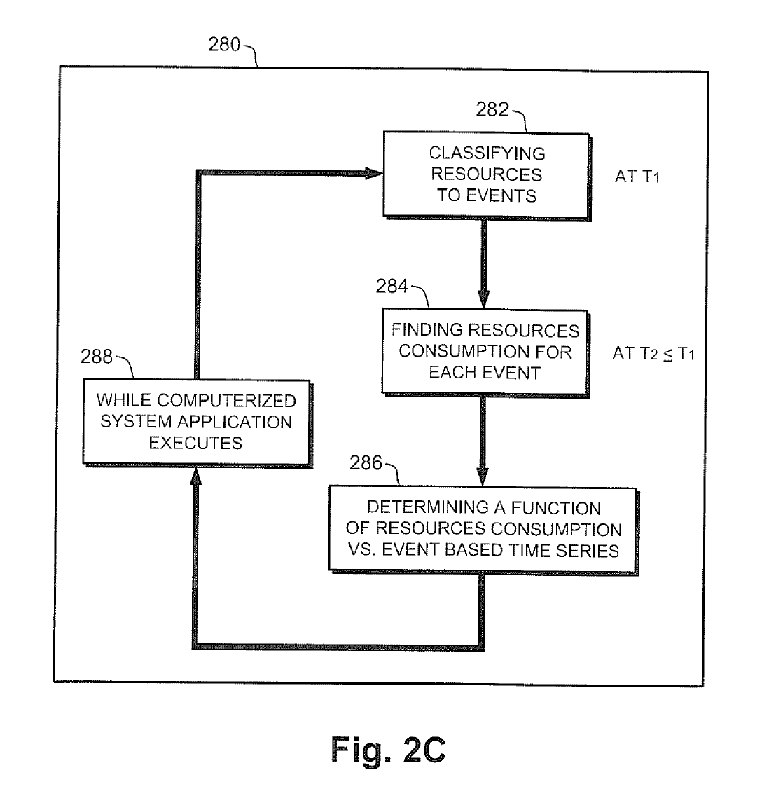

FIG. 2A illustrates a block diagram of the apparatus of the event diagnosis in the computerized system of the present invention, generally referenced 200. The apparatus 200 for diagnosis of the computerized system shown in association with FIG. 1 is preferably implemented within a computing platform. Persons skilled in the art will appreciate that many different kinds of computerized systems may be diagnosed by the apparatus 200 and that the apparatus 200 may be linked locally or remotely via network 204 to various monitoring elements shown in association with FIG. 1. Network 204 can be a packet centric data network, such as a Local Area Network (LAN), a Wide Area Network (WAN), a wireless network and the like. In some exemplary embodiments of the present invention, the platform comprises a central processing unit, a storage device and a communication device. The platform can be a personal computing device or any other computing device comprising said elements. The computing platform can be located in any section along the computerized system, including but not limited to any node, section, intersection, and also remote to said computerized system. The apparatus 200 of the present invention preferably comprises a collecting module 202 for collecting events or extracting data about the computerized system. Collecting module 202 is operative to collect events generated by an element of the computerized system or to extract data gathered by one or more monitoring tools of the computerized system. In some exemplary embodiments of the present invention, collecting events or extracting data from the computerized system can be performed by dedicated scripts that are implemented at different locations of the computerized system. Alternatively a sniffing program or a port mirror program can be used for collecting network traffic from which events or resource data can be extracted in accordance with the computerized system. It will be appreciated by persons skilled in the art that the collecting scripts will collect events transmitted by elements of the computerized system or extract data or do both, therefore should monitor certain nodes or connect to existing one or more monitoring tools at the computerized system either directly or using TCP/IP or any other form of connection. A non limiting example of a collecting script appears below:

```
#!/bin/ksh
#
mydir=‘dirname $0‘
MYDIR=‘( cd $mydir ; pwd -P )‘
MEL=‘basename $0‘
ME=‘echo $MEL | sed 's/\.ksh//‘
# run once : build headers
echo “Building headers”
> ${ME}.headers
echo “‘date‘” >> ${ME}.headers
echo “=== ps -ef ===” >> ${ME}.headers
ps -ef >> ${ME}.headers
echo “=== vmstat -dS Disk Transfers ===” >> ${ME}.headers
vmstat -dS 1 2 >> ${ME}.headers
echo “=== vmstat -f forks ===” >> ${ME}.headers
vmstat -f >> ${ME}.headers
echo “=== vmstat -s ===” >> ${ME}.headers
vmstat -s >> ${ME}.headers
echo “=== swapinfo -mtan ===” >> ${ME}.headers
swapinfo -mtan >> ${ME}.headers
echo “=== iostat ===” >> ${ME}.headers
iostat -t 1 2 >> ${ME}.headers
echo “=== nfsstat -m ===” >> ${ME}.headers
nfsstat -m >> ${ME}.headers
echo “=== nfsstat ===” >> ${ME}.headers
nfsstat >> ${ME}.headers
echo “=== netstat -s ===” >> ${ME}.headers
netstat -s >> ${ME}.headers
echo “=== sar ‘date‘ ===” >> ${ME}.headers
options=“u d q b w c a y v m”
for op in $options
do
  echo “=== sar -${op} ===” >> ${ME}.headers
  sar -${op} 1 2 >> ${ME}.headers
done
# +++++++
#mydir=‘dirname $0‘
#MYDIR=‘( cd $mydir ; pwd -P )‘
#MEL=‘basename $0‘
ME=‘echo $MEL | sed 's/\.ksh//‘_‘date +%C%y%m%d_%H%M‘
export interval=15
echo “Starting collection of system information” | tee ${ME}.log
# Main program
i=1
while [ TRUE ]
#while [ $i -lt 3 ]
do
echo “$i -th iteration”
echo “‘date‘” >> ${ME}.log
echo “=== ps -ef ===” >> ${ME}.log
ps -ef >> ${ME}.log
echo “=== vmstat -dS Disk Transfers ===” >> ${ME}.log
#vmstat -dS 1 2 | sed 's/[\hat{ }0-9][\hat{ }0-9]*/ /g ; s/ */ /g ’ >> ${ME}.log
vmstat -dS 1 2 | sed 's/[a-zA-Z:][a-zA-Z:]*[\hat{ }a-zA-Z0-9:]/ /g ; s/[a-zA-Z:][a-zA-
Z:]*$/ /g ; s/ */ /g ’ >> ${ME}.log
echo “=== vmstat -f forks ===” >> ${ME}.log
#vmstat -f | sed 's/[\hat{ }0-9][\hat{ }0-9]*/ /g ; s/ */ /g ’ >> ${ME}.log
vmstat -f | sed 's/[\hat{ }0-9\.][\hat{ }0-9\.]*/ /g ; s/[ ][ ]*/ /g ’ >> ${ME}.log
echo “=== vmstat -s ===” >> ${ME}.log
vmstat -s | sed 's/[\hat{ }0-9][\hat{ }0-9]*/ /g ; s/ */ /g ’ >> ${ME}.log
echo “=== swapinfo -mtan ===” >> ${ME}.log
#swapinfo -mtan | egrep -v ‘Mb|TYPE’ | sed 's/ */ /g ’ >> ${ME}.log
swapinfo -mtan | sed 's/\hat{ }.*START.*/ / ; s/\hat{ }TYPE.*/ / ; s/ */ /g ;s/%//g’ >>
${ME}.log
echo “=== iostat ===” >> ${ME}.log
iostat -t 1 2 | sed 's/[a-z][a-z][a-z]*/ /g ; s/[ ][ ]*/ / g ’ >> ${ME}.log
echo “=== nfsstat -m ===” >> ${ME}.log
nfsstat -m | sed 's/from//g ; s/[ ,][a-zA-Z][a-zA-Z]*[:=]/ /g; s/ */ /g’ >>
${ME}.log
echo “=== nfsstat ===” >> ${ME}.log
nfsstat | sed 's/[)(a-zA-Z:%+][)(a-zA-Z:%+]*/ /g; s/[ ][ ]*/ /g’ >>
${ME}.log
echo “=== netstat -s ===” >> ${ME}.log
# netstat -s | sed 's/[a-zA-Z][a-zA-Z]*//g’ >> ${ME}.log
netstat -s | sed 's/[a-zA-Z:][a-zA-Z:]*[\hat{ }a-zA-Z0-9:]/ /g ;s/[a-zA-Z:][a-zA-Z:]*$/ /g
; s/[ ][ ]*/ /g ;s/(//g; s/)//g ; s/I.*//g ; s/ipv6/ /; s/icmpv6/ /’ >> ${ME}.log
echo “=== sar ‘date‘ ===” >> ${ME}.log
options=“u d q b w c a y v m”
for op in $options
do
  echo “=== sar -${op} ===” >> ${ME}.log
  sar -${op} 1 2 | sed 's/Average/1234567/; s/.*[a-z+%/][a-z+%/][a-z+%/]*.*/ /g ;
s/ */ /’ >> ${ME}.log
done
i=$((i+1))
echo sleep $interval
sleep $interval
done
cat ${ME}.log | sed 's/1234567/Average/‘ >o ; mv o ${ME}.log
```

In another exemplary embodiment of the present invention, the collecting module 202 can use existing tools or use the computerized system tools 100 of FIG. 1 in order to extract data generated by the monitoring tools associated with the computerized system. Non limiting examples for monitoring tools are network monitoring tool 104, web server monitoring tool 106, application server monitoring tool 107, database monitoring tool 108, storage monitoring tool 109 and end-user experience monitoring tool 102 of FIG. 1. The user experience monitoring tool 102 can be Topaz manufactured by Mercury Interactive, CA, USA. The database monitoring tool 109 can be Quest Central manufactured by Quest Software, CA, USA. In other preferred alternatives of the present invention, database monitoring tool can be substituted by a storage monitoring tool or used in addition thereto. The storage monitoring tool 109 can be SANscreen manufactured by Onaro Inc, MA USA. The application server monitoring tool 107 can be Introscope manufactured by Computer Associates, NY, USA.

A person skilled in the art will appreciate that each one or any combination of the monitoring tools can be used for collecting events or resource data. The apparatus 200 of the present invention further comprises a transforming module 220 for transforming the information stored on the database or repository 210 to a predetermined meaningful mathematical representation form to be analyzed by analyzing module 230 for further processing. Transforming module 220 transforms the computerized system events to events based time series. The transforming module 220, in some exemplary embodiments of the present invention, stores the predetermined representation form at the database 210.

Computerized system for multiple users may generate few events of the same event type therefore in some exemplary embodiments of the present invention, the events collected or data extracted by collecting module 202 are classified by event types. Event type, in accordance with the preferred embodiment of the present invention, is a computer routine or a subroutine or a function or a set of one or more computer code lines that require an input data and have an output. Different input or output of the same subroutine or a function or a set of one or more computer code lines is referred as a different event. Alternatively, events that differ in their input or output but are a result of the same computer routine or computer function are attributed to the same event type. Therefore, one event can have a longer response time than another, but yet they are of the same event type. A person skilled in the art will appreciate determining which resource of the computerized system is used by which event type instead of using each event for that determination. In non limiting examples of the present invention, event type can include SQL command or HTTP URL request or SAP transaction code. An SQL command can be “select * from table EMPLOYEE where ID=? and NAME=?”. An SQL command can also be “select ID, NAME, DATA from Employee where COMPANY=?” or “update table EMPLOYEE set NAME=? where ID=?”. An HTTP request can be any of the following:

GET hot-web-03/cortal/servlet/CM/INTERNAL/LAYOUT?item_id=?;
GET /cortal/servlet/CM/ITEM/GET
format=xml&item_type=DOCUMENT&item_type=BREAKINGNEWS;
GET /cortal/servlet/CM/SESSION/GET http://hot-web-
03/cortal/servlet/CM/INTERNAL/LAYOUT?item_id=?; or
POST /app-cortal/customization/customImages/layout/envelope+on.jpg.

A SAP transaction event can be ZGM_GRANT_STATUS;GPV1TRUC914. A SAP transaction event can also be ME51N; PRGV156 GH or STA05; GVPX.

In the context of the present invention, events collected or data extracted can be also described as information collected or extracted. Sniffing programs or port mirror programs can be used, in some exemplary embodiments of the present invention, for collecting network traffic, from which events or resource data can be extracted.

The apparatus 200 of the present invention further comprises a database or repository module 210 for storing the information collected by extracting or collecting module 202 or by a transforming module 220 or by an analyzing module 230 or by a data visualization module 240 or a combination of the said modules. The Database module 210 stores the information about the event generated by the element of the computerized system in a database or a repository. Any type of database device can be used as the database module 210 of the present invention. In a non limiting example, the database module 210 of the present invention is an SQL generated database, produced and manufactured by the Microsoft Corp, Washington, USA. The apparatus 200 for diagnosis of the computerized system of the present invention further comprises a transforming module for transforming the at least one event or at least one data element to an at least one event based time series as further described at FIG. 2B. The apparatus 200 further comprises an analyzing module 230 for performing event diagnosis of the information collected by collecting module 202 and stored in the database or repository module 210 or transmitted by the transforming module 220. As further described in greater detail in FIG. 2C the analyzing module 230 first classifies which resources of the computerized system are consumed by which events, for a first predetermined time interval. The event based time series can have one or more time intervals. Analyzing module 230 next determines a function between the event based time series and the time the resource was consumed by that event for a second predetermined time interval. In some exemplary embodiments of the present invention, the analyzing module 230 stores the event diagnosis analysis results or part of the results at the database or repository 210. In some exemplary embodiments of the present invention, the apparatus 200 for diagnosis of the computerized system of the present invention further comprises a data visualization module 240 for receiving and presenting the results of the event diagnosis performed by analyzing module 230. The data visualization module 240, in some exemplary embodiments of the present invention, stores the presenting results at the database 210. In some alternative embodiments of the present invention, the apparatus 200 further comprises a display module (not shown) for viewing the results of the event diagnosis received from data visualization module 240 or from the database or repository 210. In one exemplary embodiment of the present invention the display is a computer screen or a television screen or like display devices. In another exemplary embodiment of the present invention, the display module is one or more of the computerized system displays throughout which the end user or an administrator or others may view the results of the analysis performed by the apparatus 200 of the present invention. In some exemplary embodiments of the present invention data visualization module 240 of FIG. 2 may prompt or alert the user on a display module for any anomaly of the event profile of the computerized system comparing an exact event profile function or function extrapolation, implying possible future malfunctioning. A person skilled in the art will appreciate that the function can be any function including linear function or a non linear function.

FIG. 2B illustrates a block diagram of the method of operation of the event diagnosis in the computerized system, in accordance with the preferred embodiment of the present invention. The method for diagnosis of a computerized system such as the computerized system disclosed in association with FIG. 1 is preferably executed by the apparatus 200 of FIG. 2A. In step 270 the apparatus 200 of FIG. 2A collects information about the computerized system. In this step data or events generated by an element of the computerized system can be collected or extracted. The use of the word extract denotes extraction of information from available monitoring elements 100 in association with FIG. 1. The use of the word collect also denotes the monitoring of different resources in the computerized system shown in FIG. 1 and collecting events that potentially consume such resources. In some exemplary embodiments of the present invention, collection of events or extraction of data will only be performed on predetermined variables or sources available in the computerized system shown in FIG. 1. Events are extracted either from the network sniffing data or directly collected from log files or data resources of the different tiers of the computerized system. For extracting events from network data, a predetermined phrase is provided to a parser according to a protocol over which the network data and the events are passed between the different tiers. Analysis of the parser's results provide for the event code, start time and end time which then are stored at database 210 of FIG. 2A. In some exemplary embodiments of the present invention, the protocols are HTTP, SQL*NET, IIOP, SOAP, RMI, AJP12, AJP13, RPC and a like. The protocols are dependant of the components composing the different tiers of the computerized system. In a non limiting example of the present invention, the parser can use the phrase GET or POST for determining the beginning of an HTTP1.1 event. In another non limiting example the parser can use the phrase SELECT or UPDATE for determining the beginning of an Oracle9i SQL*NET request. A beginning of an event of SQLServer TNS protocol can be the phrase EXEC or SELECT. Typically, the information collected or extracted will be categorized according to events or event types.

The events generated by the computerized system are monitored constantly and time tagged according to their appearance (start time) and termination (end time) while the resources are being monitored at a predetermined time intervals. A non limiting time interval is 15 seconds. In step 272 the information collected by apparatus 200 is stored at the database module 210. In some alternative embodiments of the present invention, the step of storing the information at the database module will occur after the data is transformed, analyzed or visualized as is described below. Next, in step 274 the information collected or extracted is transformed to a predetermined form to be preferably analyzed by analyzing module 230 of FIG. 2A for further processing. In this step, the computerized system events are transformed to an event based time series by summing all the active executed events, which belong to the same event type, within the monitoring predetermined time interval for each resource. Then, for each time interval and for each event type the equation event type multiply by a constant equals to a resource consumption time or utilization percentage can be written. The said sets of equations are to be solved by the analyzing module 230 of FIG. 2A.

In step 280 the apparatus 200 of FIG. 2A performs an event diagnosis of the information collected by collecting module 202 and stored by database 210 previously transformed by transforming module 220. Step 280 is described in details in FIG. 2C below. Next, in step 294 the apparatus 200 of FIG. 2A generates a report containing results of the analysis module 280. In some exemplary embodiments of the present invention, the results are shown on a display by the data visualization module 240 of FIG. 2A or stored at the database or repository 210 of FIG. 2A or are sent to a predetermined person, such as a user, an administrator or other external module for further processing. In a non limiting example of the present invention the said external module is a resource management system, error management system and the like.

FIG. 2C illustrates a block diagram of step 280 of FIG. 2B of the method of operation of the analyzing module 230 of FIG. 2A. In step 282 the analyzing module 230 of FIG. 2A classifies which resources of the computerized system are consumed by which events, for a first predetermined time interval. A person skilled in the art will appreciate the various mathematic techniques for the said classification. In a non limiting example the said classification can be done by applying correlation techniques such as Pearson and Spearman correlation tests and applying a predefined correlation threshold. The event based time series can have one or more time intervals. In step 284 analyzing module 230 of FIG. 2A finds for each event type the share of resource consumption for a second predetermined time interval. Next, in step 286 analyzing module 230 determines a function between the event based time series and the time the resource consumed that event for the second predetermined time interval. The second predetermined time interval is contained in or equal to the first predetermined time interval. In some exemplary embodiments of the present invention, the function is a linear function. In a non limiting example, determining the linear function between the at least one event based time series and the at least one measurable attribute of the at least one resource for the at least one event comprises the use of a minimum least square method. Minimum least square method comprises a step of measuring the distances between the required linear function and all the data points. Next, the required linear function is modified such that the sum of the measured distances between the required linear function and all the data points is minimized. In other exemplary embodiments of the present invention, the function is a non linear function. Alternatively, determining the linear function may comprise the use of iteratively introducing weights into the set of the linear equations which describes the relation between the event or event type and the resources. The weights are the relation coefficients at the said linear equations. The weights are iteratively changed until a predetermined condition is satisfied or the predetermined threshold is reached. Next, in step 288, the function is continued to be calculated for a third predetermined time interval different from the second predetermined time interval and contained in the first predetermined time interval such that for each time interval an event profile model can be provided determining which event is using which resource, when and how much of the resource is utilized by the event.

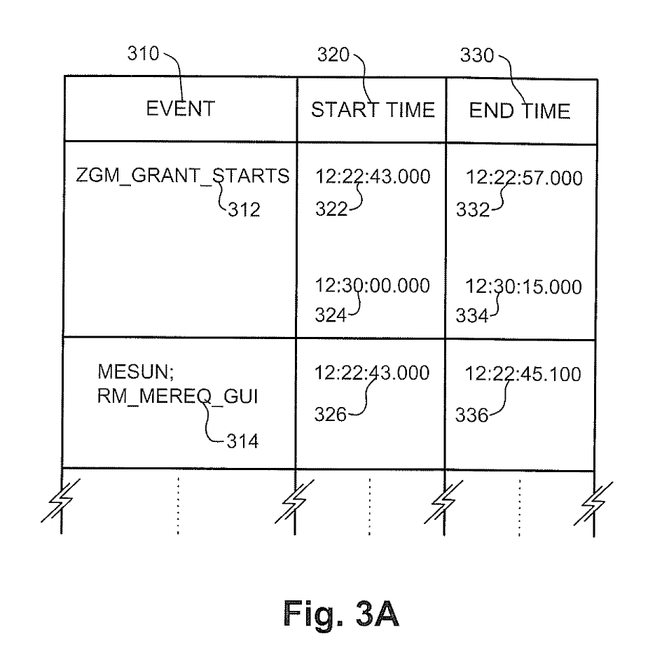

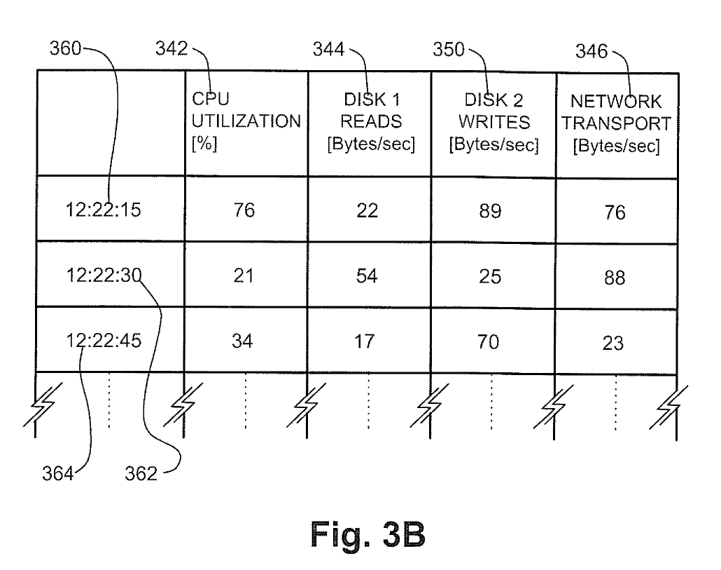

FIGS. 3A, 3B are a schematic illustration of exemplary information recorded and stored in database or repository 210 of FIG. 2A by the collecting data module 202 of FIG. 2A, in accordance with a preferred embodiment of the present invention. As shown in FIG. 3A, in exemplary embodiments of the present invention, the information is preferably stored in a table form storing for each event, the event name, the event start time and the event end time. Each event can be identified by a name, identifying number and a like. The schematic exemplary table of FIG. 3A is a non limiting example for storing the collected or extracted information at database 210 of FIG. 2A. The table titles are event name 310, start time 320, end time 330. Other suitable titles or headers may be used in similar exemplary tables and the titles or headers do not serve to limit the scope of the information that can be stored in database 210 of FIG. 2A which is associated with events collected or data extracted. The event ZGM_GRANT_STARTS 312 starts to consume a resource or a number of resources at 12:22:43.000 (322) (12 hours, 22 minutes, 43 seconds, 0 milliseconds) and finishes to use the said resources at 12:22:57.000 (332). At the collecting data step 270 of FIG. 2B the resource or resources being consumed by the event ZGM_GRANT_STARTS 312 are unknown. The time resolution is predetermined according to the event diagnosis purposes, second or millisecond resolution is adequate for practical purposes. The same event ZGM_GRANT_STARTS 312 also starts to consume a resource or resources at 12:30:00.000 (324) and finishes at 12:30:15.000 (334). Another non limiting example is event MESUN; RM_MEREQ_GUI 314 which starts to consume a resource or resources at 12:22:43.000 (326) and finishes to use resources at 12:22:45.100 (336). A person skilled in the art appreciates classification of events to event types and storing the information regarding event types in addition or instead of the information regarding the events at database 210 of FIG. 2A. Therefore, event 310 at the schematic exemplary table of FIG. 3A can be referred to as event type and the non limiting examples: ZGM_GRANT_STARTS 312 and MESUN; RM_MEREQ_GUI 314 can be referred to as event types comprising a lot of single events generated by the computerized system

As shown in FIG. 3B, in exemplary embodiments of the present invention, the information is preferably stored in a table form storing for each resource, the utilization of the resource at a predetermined time interval. In some exemplary embodiments of the present invention, the time intervals, in which the different resources of the computerized system are monitored, are constant.

At 12:22:15 (360) (12 hours, 22 minutes, 15 seconds) the CPU utilization 342 was 76 percent. The reading from DISK 1 (344) was 22 bytes per second. The writing to DISK 2 (350) was 89 bytes per second and the network transported bytes 346 were 76 per second. Next, after 15 seconds at 12:22:30 (362), the CPU 342 utilization was 21 percentages. The reading from DISK 1 (344) was 54 bytes per seconds. The writing to DISK 2 (350) was 25 bytes per seconds and the network transported bytes per second (346) were 88.

A person skilled in the art will appreciate the different resources attributes that can be measured for determining the utilization of the said different resources. A non limiting example for different resources is a logical disk; a physical disk; a processor; a computerized system or subsystem and a like. A non limiting example for the different resources attributes is any one or combination of the following: time; consumed time; speed; network speed; storage space; available space; space; free space; hit rate or byte rate; read or write queue length; average queue length; temporary queue length; read or write time; transfer time; idle time; split i/o; packets; packets received; packets sent; packets per sec; bandwidth; received bytes; page faults; available bytes; committed bytes; commit limit; write copies; transition faults; cache faults; demand zero faults; pages input; page reads; pages output; pool paged; pool nonpaged; page writes; free system page table entries; cache; cache peak; pool paged resident; system code total; system resident code; system total resident; system total driver; packets received; packets sent; packets error; packets unknown; system driver; system resident driver; system resident cache; committed in use; processor time; user time; interrupt; threads; processes; system up time; alignment fixups; exception dispatches; floating emulations; registry quota in use; file read operations; file write operations; file control operations; file read bytes; file write bytes; file control bytes; context switches; system calls: file data operations; system up time; processor queue length; memory page faults; page file sys usage; page file sys peak; and the like. One or more of the said attributes can be measured per seconds; bytes per seconds; seconds; bytes; bytes length; queue length; packets and the like. Persons skilled in the art will appreciate that any other now available or later used or developed resource attributes and measurements are contemplated by the present invention.

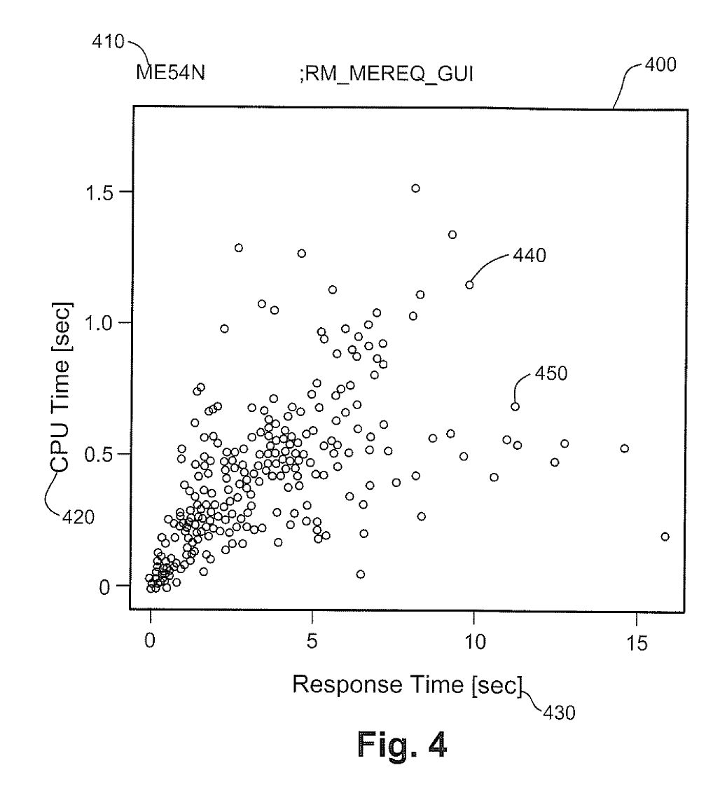

FIG. 4 is a graph showing an exemplary consumption of a resource by an event type, generally referenced 400. In accordance with one exemplary embodiment of the present invention, a graph 400 of a resource consuming time versus the event response time for a specific event type can be plotted over a few days time scale. In other embodiments of the present invention any time scale can be used for plotting graph 400. Graph 400 can typically be plotted for each event type generated by the computerized system. In the present example, graph 400 is plotted for event type ME54N;RM_MEREQ_GUI 410 for consuming the CPU resource. Y-axis of graph 400 represents CPU utilization time 420 and X-axis represents the event response time 430. In the present example, graph 400 is plotted over a five day period for predetermined time intervals; therefore each point represents the consumption of the CPU and response time of the event within the five day period. One point 440 represents a consumption time of about 1.1 sec and a response time of about 9 sec. Another point 450 represents a consumption time of about 0.7 sec and a response time of about 11 sec. In the present example, there is no defined linear relation between over all response time 430 of event 410 and its resource consumption 420. It is to be noted, that step 286 of FIG. 2C of analyzing module 230 of FIG. 3A determines a function between the event based time series and the time the resource was consumed by that event for the second predetermined time interval. The second predetermined time interval is contained in or equal to the first predetermined time interval. A person skilled in the art will appreciate that determining a linear function is performed intermittently rather than for the entire data for the entire time interval. Event diagnosis in the computerized system can be further understood as finding the exact event profile while taking into consideration substantially the entire possible resources consumption across substantially all tiers of the application: client 170 of FIG. 1, firewall 160 of FIG. 1, load balancer 140 of FIG. 1, web servers 150 of FIG. 1, database 120 of FIG. 1, storage 110 of FIG. 1, network and a like. Next, a model of substantially the entire computerized system can be made from a performance perspective point of view: what event is using what resource, when and how much of the resource is utilized by the event. Having exact event resource consumption profile for each time interval (second predetermined time interval, third predetermined time and a like) may help the user improving the performance of the computerized system. In some exemplary embodiments of the present invention the user may detect through receiving notice from the event diagnosis apparatus of the present invention that the root cause of slow event response time is a malfunction of a hard disk and will thereafter increase the hard disk throughput threshold thus solving the root cause. In another exemplary embodiment of the present invention the user may manipulate other system configuration parameters such as system cache, system paging, network throughput, I/O controller throughput and a like in order to avoid possible future malfunctioning or solve the root cause of existing malfunctioning or reduced performance. In other exemplary embodiments of the present invention data visualization module 240 of FIG. 2A may prompt or alert the user on a display module for any anomaly of the event profile of the computerized system comparing the exact event profile linear function or linear function extrapolation, implying possible future malfunctioning. In another exemplary embodiments of the present invention there is provided an apparatus and a method for detecting phenomena such as a single over consuming event, a group of over consuming events, a single resource bottleneck which occurs when all event are consuming the same resource, events deadlock situation which can be revealed when the sum of the resources' utilization time for a specific event is less than the overall response time, and a like.

Such a model of event to resource relation is essential for automatic problem and root-cause detection. A person skilled in the art will appreciate the management and operational advantages of determining a model in a real time for any dynamic system.

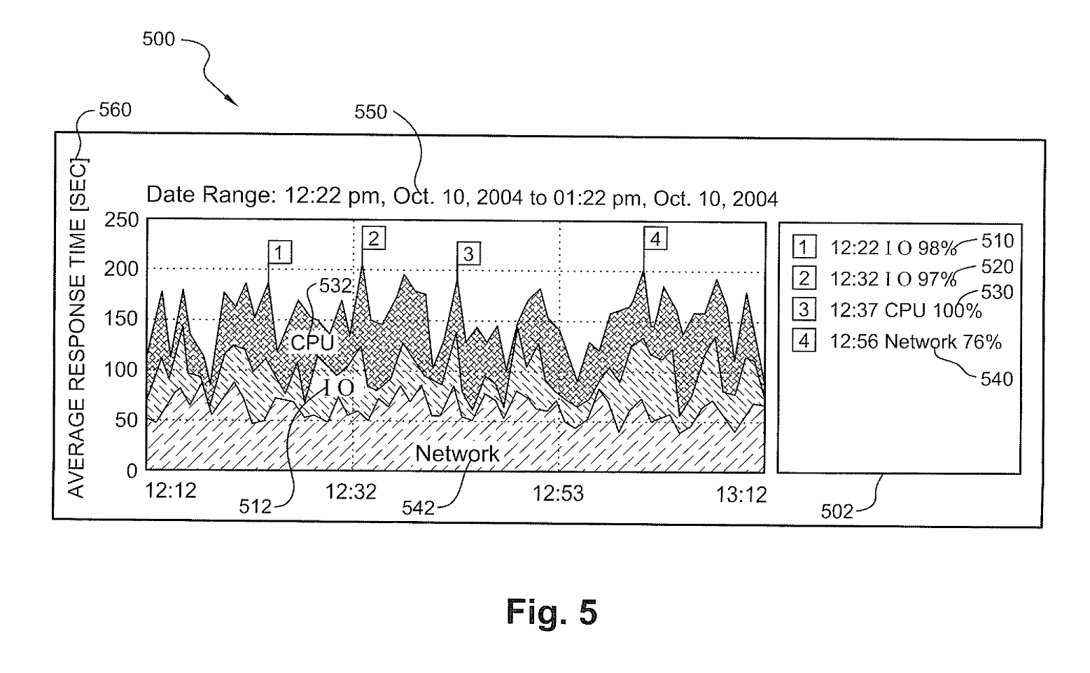

FIG. 5 is a schematic illustration of an exemplary display result of the resources consumption by substantially all the event types of the computerized system, generally referenced 500. Exemplary display 500 shows a graph that represents the consumption of a three resources' computerized system by a specific event type (name or ID of the event type is not shown) over a period of time of one hour, between 12:12 to 13:12, on Oct. 10, 2004. Title 550 outline the date and the one hour period for which graph 500 is plotted. Y axis represents the average response time of the specific event and the percentage of time the event was consuming each resource. X axis represent the time of resource sampling. In the present example, more time is spent by the specific event in consuming network resource 542 than consuming I/O resource 512 or consuming of CPU resource 532. For isolating moment in time in which the specific event type is over consuming a specific resource, peaks of resource consumption are marked for all resources in a legend box 502. The legend box 502 shows a resource consumption peak 510 at 12:22 showing a 98% I/O usage. The legend box 502 also shows a resource consumption peak 520 at 12:32 showing a 97% I/O usage. Legend box 502 shows a resource consumption peak 530 at 12:37 showing a 100% CPU usage, and a resource consumption peak 540 at 12:56 showing a 76% network usage. It will be appreciated that other resource consumption peaks can be shown on legend 520 and in graph 500. Alternatively, the legend box 502 can provide an indication about an event consumption that may cause a resource to peak and not indicating about unusual event consumption that is not causing resources' overloads or bottlenecks. Still referring to FIG. 5 the Y axis represents average response time of a specific event type 560. The stacked graphs within the average response time display the distribution of the response time of the specific event type, between the different resources from an event perspective. In other words, the legend box 502 shows what can be seen from a resource perspective. Generally, from an event perspective, it is possible that for a specific time frame the event will spend an exemplary 40% of his time in I/O consumption, instead of its exemplary “usual” 20%, but still such consumption is not substantially causing bottlenecks or malfunction to the I/O resource. However, there could be a time frame in which the event spends an exemplary 25% of his time in I/O consumption, but said exemplary 25% substantially cause the I/O resource to peak.

In another exemplary embodiment of the present invention exemplary display 500 represents a graph of the consumption of a specific resource by substantially all the events or events type of the computerized system (not shown) over one hour between 12:12 to 13:12 on Oct. 10, 2004. Title 550 outlines the date and the one hour period for which graph 500 is plotted. Y axis represents the specific resource utilization and each layer represents a consumption level of a single event or event type. In a non limiting example the consumption of a first event type 542 over the diagnosed period is lower than the consumption of a second event type 532 and the consumption of a third event type 512. Peaks of the specific resource consumption are marked for all plotted event types in a legend box 502. A single resource bottleneck which occurs when all event are consuming the same resource can be easily diagnosed using the exemplary embodiment.

The person skilled in the art will appreciate that what has been shown is not limited to the description above. The person skilled in the art will appreciate that examples shown here above are in no way limiting and are shown to better and adequately describe the present invention. Those skilled in the art to which this invention pertains will appreciate the many modifications and other embodiments of the invention. It will be apparent that the present invention is not limited to the specific embodiments disclosed and those modifications and other embodiments are intended to be included within the scope of the invention. Although specific terms are employed herein, they are used in a generic and descriptive sense only and not for purposes of limitation. Persons skilled in the art will appreciate that the present invention is not limited to what has been particularly shown and described hereinabove. Rather the scope of the present invention is defined only by the claims, which follow.

I/We claim:

1. A method for diagnosis of a computerized system, the method is implemented within a computing platform, the platform comprises at least one processing unit, at least one storage device; and at least one communication device, the method comprising the steps of:
collecting at least one event or extracting at least one data element generated by an element of the computerized system;
transforming the at least one event or at least one data element to an at least one event based time series, said at least one event based time series having at least one interval;
determining which at least one resource of the computerized system is consumed by which of the at least one event, for a first predetermined time interval; and
determining a function between the at least one event based time series and an at least one measurable attribute of the at least one resource for the at least one event for a second predetermined time interval.

2. The method for diagnosis of a computerized system of claim 1 further comprising a step of storing the at least one event or at least one data element generated by an element of the computerized system in a database.

3. The method for diagnosis of a computerized system of claim 1 wherein the first predetermined time interval is longer than or equal to the second predetermined time interval.

4. The method for diagnosis of a computerized system of claim 1 wherein said function is a linear function.

5. The method for diagnosis of a computerized system of claim 1 wherein said function is a non-linear function.

6. The method for diagnosis of a computerized system of claim 1 wherein said measurable attribute comprises any on of the following attributes: time; consumed time; speed; network speed; storage space; available space; space; free space; bit rate byte rate; read or write queue length; average queue length; temporary queue length; read or write time; transfer time; idle time; split i/o; packets; packets received; packets sent; packets per see; bandwidth; received bytes; page faults; available bytes; committed bytes; commit limit; write copies; transition faults; cache faults; demand zero faults; pages input; page reads; pages output: pool paged; pool non paged; page writes; free system page table entries; cache; cache peak; pool paged resident; system code total; system resident code; system total resident; system total driver; packets received; packets sent; packets error; packets unknown; system driver; system resident driver; system resident cache; committed in use; processor time; user time; interrupt; threads; processes; system up time; alignment fixups; exception dispatches; floating emulations; registry quota in use; file read operations; file write operations; file control operations; file read bytes; file write bytes; file control bytes; context switches; system calls; file data operations; system up time; processor queue length; memory page faults; page file sys usage; page file sys peak.

7. The method for diagnosis of a computerized system of claim 1 wherein the second predetermined time interval is contained in the first predetermined time interval.

8. The method for diagnosis of a computerized system of claim 1 further comprising a step of determining a function between the at least one event based time series and the at least one measurable attribute of the at least one resource for the at least one event for a third predetermined time interval.

9. The method for diagnosis of a computerized system of claim 8 wherein the third predetermined time interval is different from the second predetermined time interval.

10. The method for diagnosis of a computerized system of claim 1 wherein said step of determining the function between the at least one event based time series and at least one measurable attribute of the at least one resource for the at least one event comprises the use of minimum least square method step.

11. The method for diagnosis of a computerized system of claim 11 further comprising the step of iteratively introducing weights into the said step of determining the function between the at least one event based time series and at least one measurable attribute of the at least one resource for the at least one event.

12. The method for diagnosis of a computerized system of claims 1 or 22 or 8 or 10 or 11 wherein the event is an event type.

13. The method of claims 1 or 8 or 10 or 11 wherein the at least one resource is an at least one consumed resource.

14. The method for diagnosis of a computerized system of claim 6 wherein said measurable attribute is measured by any one of the following: per seconds; bytes per seconds; seconds; bytes; bytes length; queue length; packets.

15. An apparatus for diagnosis of a computerized system, the apparatus is implemented within a computing platform, the platform comprises at least one processing unit, at least one storage device; and at least one communication device, the apparatus comprising:
a collecting module for collecting information about the computerized system;
a database for storing the information collected by the said collecting module; and
an analyzing module for performing event diagnosis on the information collected by said collecting module and stored by said database.

16. The apparatus of claim 15, further comprising a transforming module for transforming the information stored on said database to a predetermined form to be analyzed by said analyzing module for further processing.

17. The apparatus of claim 15, further comprising a data visualization module for receiving and presenting the results of the event diagnosis performed by said analyzing module.

18. The apparatus of claim 16, further comprising a display module for viewing the results of the event diagnosis received from the said data visualization module.

19. The apparatus of claim 14 wherein the event is an event type.
